(19) United States
(12) Patent Application Publication
(10) Pub. No.: US 2017/0159780 A1
(43) Pub. Date: Jun. 8, 2017

(54) DRIVE AXLE ASSEMBLY HAVING AN UNDER-DRIVE ARRANGEMENT AND METHOD OF SELECTING THE SAME

(71) Applicant: Dana Heavy Vehicle Systems Group, LLC, Maumee, OH (US)

(72) Inventor: Harry Trost, Royal Oak, MI (US)

(21) Appl. No.: 14/959,612

(22) Filed: Dec. 4, 2015

(51) Int. Cl. F16H 37/08; F16H 48/42; F16H 48/08; B60K 17/36

(52) U.S. Cl. CPC F16H 37/0813; B60K 17/36; F16H 48/42; F16H 48/08

(57) ABSTRACT

An axle assembly, a drive axle system, and a method of selecting a drive arrangement for a drive axle system are provided. The axle assembly comprises an input shaft, an under-drive arrangement, an inter-axle differential arrangement, and an axle differential arrangement. The input shaft is in driving engagement with a source of rotational energy. The under-drive arrangement is in driving engagement with the input shaft. The inter-axle differential is in driving engagement with the under-drive arrangement. The axle differential arrangement is in driving engagement with a portion of the inter-axle differential. The under-drive arrangement is configured to reduce a drive ratio of the axle assembly between the input shaft and the inter-axle differential. The axle assembly reduces parasitic losses and is compatible with conventional driveline components.

### FIELD OF THE INVENTION

The present invention relates to drive axle systems for use with vehicles having multiple drive axles.

### BACKGROUND OF THE INVENTION

Vehicles incorporating multiple drive axles benefit in many ways over vehicles having a single driven axle. Drive axle systems in such vehicles may be configured to distribute torque between the axles, increasing tractive effort. The incorporation of an inter-axle differential allows the torque to be distributed between multiple axles while providing each axle operating flexibility. As noted, these benefits require the incorporation of additional drive train components into the vehicle at added expense and weight. Such added weight results in a decreased fuel efficiency of the vehicle.

Drive axle systems may be configured with a variety of sizes of ring and drive pinion gears as a final gear reduction before driving an axle of the vehicle. By switching the ring and drive pinion gears, amongst other gears that adjust drive ratio, a standard drive axle assembly may be utilized for multiple vehicles and in different applications. However, such utility results in adjusting a range of rotational speed of the components (such as bearings used within the drive axle system) of the drive axle system. It is well known in the art that power losses of bearings increase as rotational speed does. Consequently, power loss through bearings of the drive axle system is variable depending on a ring and drive pinion gear (and other gears) selected.

Equipment manufacturers tend to use standard speed operating ranges and torque ratings when selecting components (such as a transmission and a driveshaft, for example) for a driveline used with a tandem axle system. When servicing or retrofitting a tandem axle system with components different from those with which the tandem axle system was originally equipped, such considerations must be taken into account. With ever increasing operating costs, retrofitting a tandem axle system of a vehicle with components that increase its efficiency can have substantial long-term cost savings.

It would be advantageous to develop an axle assembly for a tandem axle drive system and a method of selecting a drive arrangement for a drive axle system that reduces parasitic losses and is compatible with conventional driveline components.

### SUMMARY OF THE INVENTION

Presently provided by the invention, an axle assembly for a tandem axle drive system and a method of selecting a drive arrangement for a drive axle system that reduces parasitic losses and is compatible with conventional driveline components, has surprisingly been discovered.

In one embodiment, the present invention is directed to an axle assembly. The axle assembly comprises an input shaft, an under-drive arrangement, an inter-axle differential arrangement, and an axle differential arrangement. The input shaft is in driving engagement with a source of rotational energy. The under-drive arrangement is in driving engagement with the input shaft. The inter-axle differential is in driving engagement with the under-drive arrangement. The axle differential arrangement is in driving engagement with a portion of the inter-axle differential. The under-drive arrangement is configured to reduce a drive ratio of the axle assembly between the input shaft and the inter-axle differential.

In another embodiment, the present invention is directed to a drive axle system. The drive axle system comprises a first axle assembly and a second axle assembly. The first axle assembly comprises an input shaft in driving engagement with a source of rotational energy, an under-drive arrangement in driving engagement with the input shaft, an inter-axle differential in driving engagement with the under-drive arrangement, an output shaft in driving engagement with a first portion of the inter-axle differential, and a first axle differential arrangement in driving engagement with a second portion of the inter-axle differential. The second axle assembly is in driving engagement with the output shaft and comprises a second axle differential arrangement. The under-drive arrangement is configured to reduce a drive ratio of the first axle assembly and the second axle assembly between the input shaft and the inter-axle differential.

In yet another embodiment, the present invention is directed to a method of selecting a drive arrangement for a drive axle system. The method comprises the steps of: selecting an overall drive ratio for the drive axle system, wherein the drive axle system includes a first axle differential arrangement, a second axle differential arrangement, a drop gear arrangement, an inter-axle differential, and an under-drive arrangement; selecting a drive ratio for a first axle drive pinion and the first axle differential arrangement that minimizes a power consumption of the drive axle system; selecting a drive ratio for a second axle drive pinion and the second axle differential arrangement that minimizes a power consumption of the drive axle system; selecting a drive ratio for the drop gear arrangement that minimizes a power consumption of the drive axle system, the drop gear arrangement for driving one of the first axle drive pinion and the second axle drive pinion; and selecting a drive ratio for the under-drive arrangement that results in the previously selected overall drive ratio for the drive axle system, wherein the under-drive arrangement is drivingly engaged with an input shaft and the inter-axle differential, the outputs of the inter-axle differential drivingly engaged with the drop gear arrangement and one of the first axle drive pinion and the second axle drive pinion.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic view of a drive axle system including an axle assembly according to an embodiment of the present invention;

FIG. 2 is a schematic view of a drive axle system including an axle assembly according to another embodiment of the present invention;

FIG. 3 is a chart illustrating an amount of power consumption versus a drive ratio of a conventional drive axle system and the drive axle system according to the embodiments of the invention; and

FIG. 4 is a line chart illustrating an amount of fuel savings versus a drive ratio of the drive axle system according to the embodiments of the invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts of the present invention. Hence, specific dimensions, directions, orientations or other physical characteristics relating to the embodiments disclosed are not to be considered as limiting, unless expressly stated otherwise.

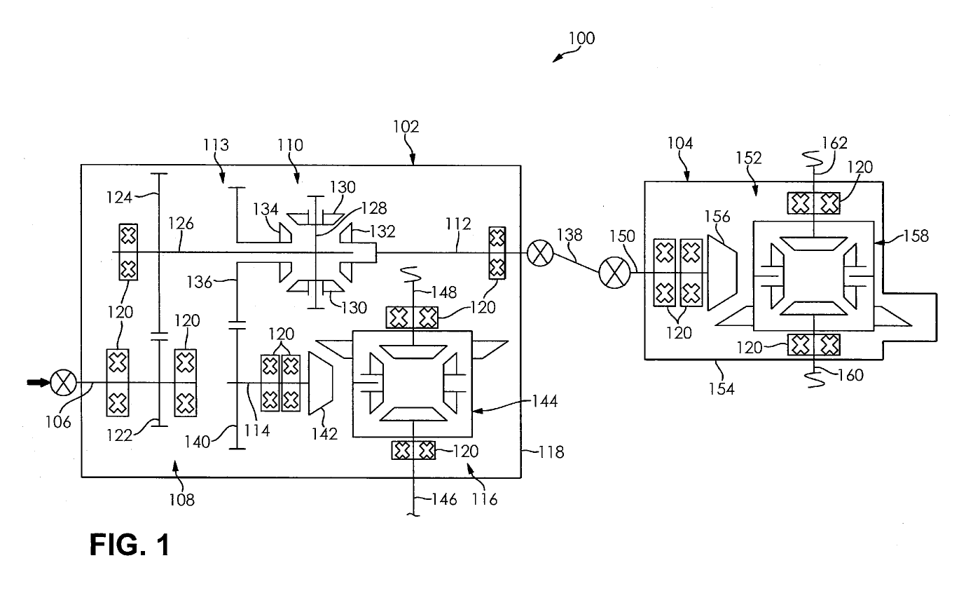

FIG. 1 illustrates a drive axle system 100 according to an embodiment of the invention. The drive axle system 100 comprises a first axle assembly 102 and a second axle assembly 104. The first axle assembly 102 is in driving engagement with a vehicle transmission (not shown) and the second axle assembly 104.

The first axle assembly 102 includes an input shaft 106, an under-drive arrangement 108, an inter-axle differential 110, an output shaft 112, a drop gear arrangement 113, a first axle drive pinion 114, and a first axle differential arrangement 116. The under-drive arrangement 108, the inter-axle differential 110, the output shaft 112, the drop gear arrangement 113, and the first axle drive pinion 114 are disposed in a housing 118. As shown in FIG. 1, the first axle assembly 102 divides power applied to the input shaft 106 and the under-drive arrangement 108 using the inter-axle differential 110. The inter-axle differential 110 is in driving engagement with both the first axle differential arrangement 116 and the second axle assembly 104. It is understood that the drive axle system 100 shown in FIG. 1 may be modified through the addition of features such as an axle disconnect, an inter-axle differential lock, a clutching system that facilitates disconnection of a portion of the drive axle system 100, or a clutching system that facilitates variable engagement of a portion of the drive axle system 100 to facilitate re-engagement of the disconnected portion. The first axle assembly 102 is a “low entry” axle assembly, meaning that the input shaft 106 enters the housing 118 at a lower point with respect to the inter-axle differential 110 and the output shaft 112. Depending on a configuration of the vehicle transmission used with the drive axle system 100, among other factors, the “low entry” configuration may be desirable.

The input shaft 106 is disposed through the housing 118. The input shaft 106 is in driving engagement with a source of rotational energy, which causes the input shaft 106 to rotate within the housing 118. As a non-limiting example, the input shaft 106 may be configured to be in driving engagement with the vehicle transmission (not shown) through a Cardan shaft (not shown). At least one bearing 120, which may be a thrust roller bearing, is in contact with the input shaft 106 to enable it to rotate within the housing 118. A portion of the input shaft 106 is splined to facilitate driving engagement with a first gear 122 of the under-drive arrangement 108; however, it is understood that the input shaft 106 may be configured in another manner that facilitates driving engagement with the first gear 122.

The under-drive arrangement 108 comprises a pair of gears drivingly engaged with one another to reduce a drive ratio between the input shaft 106 and the inter-axle differential 110. The under-drive arrangement 108 comprises the first gear 122 and a second gear 124. As shown in FIG. 1, a diameter of the first gear 122 is smaller than a diameter of the second gear 124. As a non-limiting example, a drive ratio between the first gear 122 and the second gear 124 may be about 3:1; however, it is understood that under-drive ratios in the range of about 2.2 to about 4 may also be used. The first gear 122 and the second gear 124 are helical gears; however, it is understood other gear types may be used. As mentioned hereinabove, the first gear 122 is mounted for rotation on the input shaft 106. The second gear 124 is mounted for rotation on a differential input shaft 126. It is understood that the under-drive arrangement 108 may be the exclusive drive ratio adjusting component of the first axle assembly 102 and the drive axle system 100.

The differential input shaft 126 is rotatably mounted within the housing 118. The differential input shaft 126 is in driving engagement with the second gear 124 and the inter-axle differential 110. At least one bearing 120, which may be a thrust roller bearing, is in contact with the differential input shaft 126 to enable it to rotate within the housing 118. A first end of the differential input shaft 126 is splined to facilitate driving engagement with the second gear 124 of the under-drive arrangement 108; however, it is understood that the differential input shaft 126 may be configured in another manner that facilitates driving engagement with the second gear 124. A second end of the differential input shaft 126 is fitted with a spider 128 for rotation with the differential input shaft 126. Further, as shown in FIG. 1, the second end of the differential input shaft 126 may be journaled in a portion of the inter-axle differential 110. In response to rotation of the differential input shaft 126, the spider 128 drives the inter-axle differential 110.

The spider 128 extends radially outward from the differential input shaft 126. The spider 128 is part of the inter-axle differential 110 which also comprises a plurality of pinion gears 130. Each of the pinion gears 130 may be a bevel type pinion gear. At least two pinion gears 130 are rotatably disposed on the spider 128; however, it is understood that more may be used. The spider 128 extends into an aperture formed in each of the pinion gears 130.

The inter-axle differential 110 is a differential device rotatably disposed in the housing 118 and is in driving engagement with the differential input shaft 126, the output shaft 112, and the drop gear arrangement 113. As shown in FIG. 1, the inter-axle differential 110 is a bevel gear style differential; however, it is understood that other differential types may be used. The inter-axle differential 110 comprises the spider 128, the pinion gears 130, a first side gear 132, and a second side gear 134. The components of the inter-axle differential 110 may be disposed within a housing (not shown).

The first side gear 132 is a bevel gear in driving engagement with the pinion gears 130 and the output shaft 112. The first side gear 132 is preferably splined to the output shaft 112, but it is understood that the first side gear 132 may be engaged with the output shaft 112 in another manner. As mentioned hereinabove, the second end of the differential input shaft 126 may be journaled in a portion of the inter-axle differential 110, which may be the first side gear 132, as shown in FIG. 1.

The second side gear 134 is a bevel gear in driving engagement with the pinion gears 130 and a first gear 136 of the drop gear arrangement 113. The second side gear 134 is preferably splined to the first gear 136, but it is understood that the second side gear 134 may be engaged with the first gear 136 in another manner. As shown in FIG. 1, the second side gear 134 is disposed about the differential input shaft 126; it is understood that at least one bearing may be disposed therebetween for rotatably supporting the second side gear 134 and the first gear 136 of the drop gear arrangement 113.

The output shaft 112 is disposed through the housing 118. The output shaft 112 is in driving engagement with the first side gear 132 and the second axle assembly 104 (such as through a Cardan shaft 138, for example). At least one bearing 120, which may be a thrust roller bearing, is in contact with the output shaft 112 to enable it to rotate within the housing 118.

The drop gear arrangement 113 comprises a pair of gears drivingly engaged with one another in a 1:1 drive ratio between the second side gear 134 of the inter-axle differential 110 and the first axle drive pinion 114; however, it is understood that other similar drive ratios may be used. The drop gear arrangement 113 comprises the first gear 136 and a second gear 140. The first gear 136 and the second gear 140 are helical gears; however, it is understood other gear types may be used. As mentioned hereinabove, the first gear 136 is mounted for rotation on the differential input shaft 126. The second gear 140 is mounted for rotation on the first axle drive pinion 114.

The first axle drive pinion 114 is rotatably disposed within the housing 118. The first axle drive pinion 114 is in driving engagement with the second gear 140 and the first axle differential arrangement 116. At least one bearing 120, which may be a thrust roller bearing, is in contact with the first axle drive pinion 114 to enable it to rotate within the housing 118. A first end of the first axle drive pinion 114 is splined to facilitate driving engagement with the second gear 140 of the drop gear arrangement 113; however, it is understood that the first axle drive pinion 114 may be configured in another manner that facilitates driving engagement with the second gear 140. A second end of the first axle drive pinion 114 is fitted with a first spiral bevel gear 142 for rotation with the first axle drive pinion 114; however, it is understood that the first axle drive pinion 114 may be configured in another manner for engaging the first axle differential arrangement 116.

The first axle differential arrangement 116 is partially disposed within the housing 118. The first axle differential arrangement 116 is in driving engagement with the first axle drive pinion 114 and a pair of wheel assemblies (not shown). At least one bearing 120, which may be a thrust roller bearing, is in contact with a portion of the first axle differential arrangement 116 to enable it to rotate within the housing 118. The first axle differential arrangement 116 comprises a differential assembly 144, a first axle half shaft 146, and a second axle half shaft 148. The differential assembly 144 is a conventional differential assembly comprising a ring gear, differential housing, drive pinions, and side gears as known in the art. The side gears of the differential assembly 144 are respectively drivingly engaged with the first axle half shaft 146 and the second axle half shaft 148. The ring gear of the differential assembly 144 is drivingly engaged with the first spiral bevel gear 142 to facilitate driving engagement between the first axle drive pinion 114 and the differential assembly 144. The first spiral bevel gear 142 of the first axle drive pinion 114 is drivingly engaged with the ring gear of the differential assembly 144 in a 1:1 drive ratio; however, it is understood that other similar drive ratios may be used.

The second axle assembly 104 includes a second axle drive pinion 150 and a second axle differential arrangement 152. The second axle drive pinion 150 and the second axle differential arrangement 152 are disposed in a housing 154. As shown in FIG. 1, the first axle assembly 102 divides power applied to the input shaft 106 and the under-drive arrangement 108 using the inter-axle differential 110. The inter-axle differential 110 is in driving engagement with the second axle assembly 104 through the output shaft 112 and the Cardan shaft 138.

The second axle drive pinion 150 is rotatably disposed through the housing 154. The second axle drive pinion 150 is in driving engagement with the Cardan shaft 138 and the second axle differential arrangement 152. At least one bearing 120, which may be a thrust roller bearing, is in contact with the second axle drive pinion 150 to enable it to rotate within the housing 154. A first end of the second axle drive pinion 150 is splined to facilitate driving engagement with a yoke (not shown) forming a portion of the Cardan shaft 138; however, it is understood that the second axle drive pinion 150 may be configured in another manner that facilitates driving engagement with the Cardan shaft 138. A second end of the second axle drive pinion 150 is fitted with a second spiral bevel gear 156 for rotation with the second axle drive pinion 150; however, it is understood that the second axle drive pinion 150 may be configured in another manner for engaging the second axle differential arrangement 152.

The second axle differential arrangement 152 is partially disposed within the housing 154. The second axle differential arrangement 152 is in driving engagement with the second axle drive pinion 150 and a pair of wheel assemblies (not shown). At least one bearing 120, which may be a thrust roller bearing, is in contact with a portion of the second axle differential arrangement 152 to enable it to rotate within the housing 154. The second axle differential arrangement 152 comprises a differential assembly 158, a first axle half shaft 160, and a second axle half shaft 162. The differential assembly 158 is a conventional differential assembly comprising a ring gear, differential housing, drive pinions, and side gears as known in the art. The side gears of the differential assembly 158 are respectively drivingly engaged with the first axle half shaft 160 and the second axle half shaft 162. The ring gear of the differential assembly 158 is drivingly engaged with the second spiral bevel gear 156 to facilitate driving engagement between the second axle drive pinion 150 and the differential assembly 158.

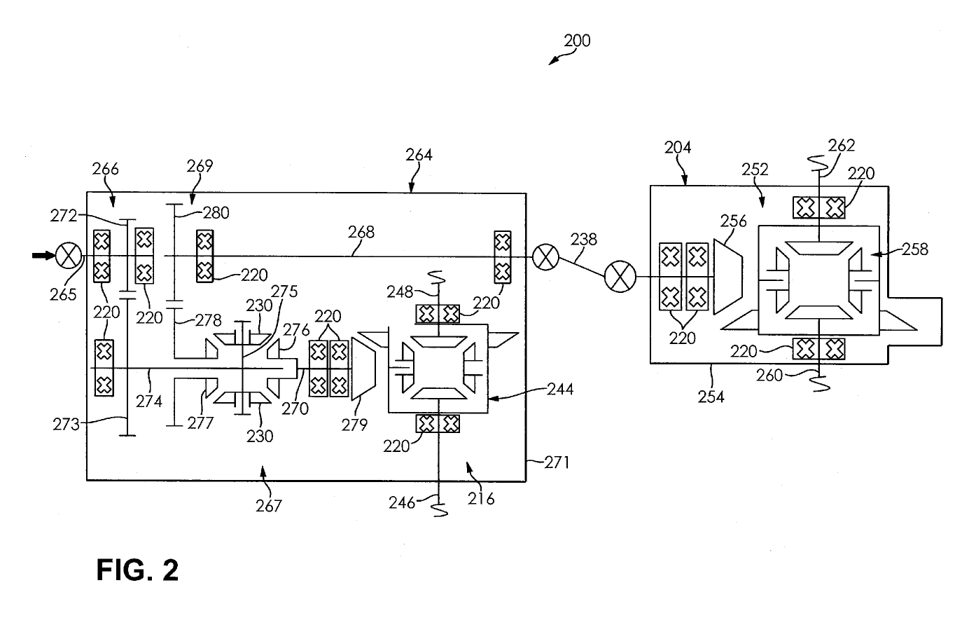

FIG. 2 illustrates a drive axle system 200 according to another embodiment of the invention. The embodiment shown in FIG. 2 includes similar components to the drive axle system 100 illustrated in FIG. 1. Similar features of the embodiment shown in FIG. 2 are numbered similarly in series, with the exception of the features described below.

The drive axle system 200 comprises a first axle assembly 264 and a second axle assembly 204. The first axle assembly 264 is in driving engagement with a vehicle transmission (not shown) and the second axle assembly 204.

The first axle assembly 264 includes an input shaft 265, an under-drive arrangement 266, an inter-axle differential 267, an output shaft 268, a drop gear arrangement 269, a first axle drive pinion 270, and a first axle differential arrangement 216. The under-drive arrangement 266, the inter-axle differential 267, the output shaft 268, the drop gear arrangement 269, and the first axle drive pinion 270 are disposed in a housing 271. As shown in FIG. 2, the first axle assembly 264 divides power applied to the input shaft 265 and the under-drive arrangement 266 using the inter-axle differential 267. The inter-axle differential 267 is in driving engagement with both the first axle differential arrangement 216 and the second axle assembly 204. It is understood that the drive axle system 200 shown in FIG. 2 may be modified through the addition of features such as an axle disconnect, an inter-axle differential lock, a clutching system that facilitates disconnection of a portion of the drive axle system 200, or a clutching system that facilitates variable engagement of a portion of the drive axle system 200 to facilitate re-engagement of the disconnected portion. The first axle assembly 264 is a “high entry” axle assembly, meaning that the input shaft 265 enters the housing 271 at a higher point with respect to the inter-axle differential 267 and the first axle drive pinion 270. Depending on a configuration of the vehicle transmission used with the drive axle system 200, among other factors, the “high entry” configuration may be desirable.

The input shaft 265 is disposed through the housing 271. The input shaft 265 is in driving engagement with a source of rotational energy, which causes the input shaft 265 to rotate within the housing 271. As a non-limiting example, the input shaft 265 may be configured to be in driving engagement with the vehicle transmission (not shown) through a Cardan shaft (not shown). At least one bearing 220, which may be a thrust roller bearing, is in contact with the input shaft 265 to enable it to rotate within the housing 271. A portion of the input shaft 265 is splined to facilitate driving engagement with a first gear 272 of the under-drive arrangement 266; however, it is understood that the input shaft 265 may be configured in another manner that facilitates driving engagement with the first gear 272.

The under-drive arrangement 266 comprises a pair of gears drivingly engaged with one another to reduce a drive ratio between the input shaft 265 and the inter-axle differential 267. The under-drive arrangement 266 comprises the first gear 272 and a second gear 273. As shown in FIG. 2, a diameter of the first gear 272 is smaller than a diameter of the second gear 273. As a non-limiting example, a drive ratio between the first gear 272 and the second gear 273 is about 3:1; however, it is understood that under-drive ratios in the range of about 2.2 to about 4 may also be used. The first gear 272 and the second gear 273 are helical gears; however, it is understood other gear types may be used. As mentioned hereinabove, the first gear 272 is mounted for rotation on the input shaft 265. The second gear 273 is mounted for rotation on a differential input shaft 274. It is understood that the under-drive arrangement 266 may be the exclusive drive ratio adjusting component of the first axle assembly 264 and the drive axle system 200.

The differential input shaft 274 is rotatably mounted within the housing 271. The differential input shaft 274 is in driving engagement with the second gear 273 and the inter-axle differential 267. At least one bearing 220, which may be a thrust roller bearing, is in contact with the differential input shaft 274 to enable it to rotate within the housing 271. A first end of the differential input shaft 274 is splined to facilitate driving engagement with the second gear 273 of the under-drive arrangement 266; however, it is understood that the differential input shaft 274 may be configured in another manner that facilitates driving engagement with the second gear 273. A second end of the differential input shaft 274 is fitted with a spider 275 for rotation with the differential input shaft 274. Further, as shown in FIG. 2, the second end of the differential input shaft 274 may be journaled in a portion of the inter-axle differential 267. In response to rotation of the differential input shaft 274, the spider 275 drives the inter-axle differential 267.

The spider 275 extends radially outward from the differential input shaft 274. The spider 275 is part of the inter-axle differential 267 which also comprises a plurality of pinion gears 230. Each of the pinion gears 230 may be a bevel type pinion gear. At least two pinion gears 230 are rotatably disposed on the spider 275; however, it is understood that more may be used. The spider 275 extends into an aperture formed in each of the pinion gears 230.

The inter-axle differential 267 is a differential device rotatably disposed in the housing 271 and is in driving engagement with the differential input shaft 274, first axle drive pinion 270, and the drop gear arrangement 269. As shown in FIG. 2, the inter-axle differential 267 is a bevel gear style differential; however, it is understood that other differential types may be used. The inter-axle differential 267 comprises the spider 275, the pinion gears 230, a first side gear 276, and a second side gear 277. The components of the inter-axle differential 267 may be disposed within a housing (not shown).

The first side gear 276 is a bevel gear in driving engagement with the pinion gears 230 and the first axle drive pinion 270. The first side gear 276 is preferably splined to the first axle drive pinion 270, but it is understood that the first side gear 276 may be engaged with the first axle drive pinion 270 in another manner. As mentioned hereinabove, the second end of the differential input shaft 274 may be journaled in a portion of the inter-axle differential 267, which may be the first side gear 276, as shown in FIG. 2.

The second side gear 277 is a bevel gear in driving engagement with the pinion gears 230 and a first gear 278 of the drop gear arrangement 269. The second side gear 277 is preferably splined to the first gear 278, but it is understood that the second side gear 277 may be engaged with the first gear 278 in another manner. As shown in FIG. 2, the second side gear 277 is disposed about the differential input shaft 274; it is understood that at least one bearing may be disposed therebetween for rotatably supporting the second side gear 277 and the first gear 278 of the drop gear arrangement 269.

The first axle drive pinion 270 is rotatably disposed within the housing 271. The first axle drive pinion 270 is in driving engagement with the first side gear 276 of the inter-axle differential 267. At least one bearing 220, which may be a thrust roller bearing, is in contact with the first axle drive pinion 270 to enable it to rotate within the housing 271. A first end of the first axle drive pinion 114 is splined to facilitate driving engagement with the first side gear 276 of the inter-axle differential 267; however, it is understood that the first axle drive pinion 270 may be configured in another manner that facilitates driving engagement with the first side gear 276. A second end of the first axle drive pinion 270 is fitted with a first spiral bevel gear 279 for rotation with the first axle drive pinion 270; however, it is understood that the first axle drive pinion 270 may be configured in another manner for engaging the first axle differential arrangement 216.

The first axle differential arrangement 216 is partially disposed within the housing 271. The first axle differential arrangement 216 is in driving engagement with the first axle drive pinion 270 and a pair of wheel assemblies (not shown). At least one bearing 220, which may be a thrust roller bearing, is in contact with a portion of the first axle differential arrangement 216 to enable it to rotate within the housing 271. The first axle differential arrangement 216 comprises a differential assembly 244, a first axle half shaft 246, and a second axle half shaft 248. The differential assembly 244 is a conventional differential assembly comprising a ring gear, differential housing, drive pinions, and side gears as known in the art. The side gears of the differential assembly 244 are respectively drivingly engaged with the first axle half shaft 246 and the second axle half shaft 248. The ring gear of the differential assembly 244 is drivingly engaged with the first spiral bevel gear 242 to facilitate driving engagement between the first axle drive pinion 270 and the differential assembly 244. The first spiral bevel gear 279 of the first axle drive pinion 270 is drivingly engaged with the ring gear of the differential assembly 244 in a 1:1 drive ratio; however, it is understood that other similar drive ratios may be used.

The drop gear arrangement 269 comprises a pair of gears drivingly engaged with one another in a 1:1 drive ratio between the second side gear 277 of the inter-axle differential 267 and the output shaft 268; however, it is understood that other similar drive ratios may be used. The drop gear arrangement 269 comprises the first gear 278 and a second gear 280. The first gear 278 and the second gear 280 are helical gears; however, it is understood other gear types may be used. As mentioned hereinabove, the first gear 278 is mounted for rotation on the differential input shaft 274. The second gear 280 is mounted for rotation on the output shaft 268.

The output shaft 268 is disposed through the housing 271. The output shaft 268 is in driving engagement with the second gear 280 of the drop gear arrangement 269 and the second axle assembly 204 (such as through a Cardan shaft 238, for example). At least one bearing 220, which may be a thrust roller bearing, is in contact with the output shaft 268 to enable it to rotate within the housing 271.

In view of the embodiments of the drive axle systems 100, 200 described hereinabove, the present invention is also directed to a method of selecting a drive arrangement for the drive axle system 100, 200. The method comprises several steps that result in the selection of components that minimize a power consumption of the drive axle system 100, 200. First, an overall drive ratio for the drive axle system 100, 200 is selected, wherein the drive axle system 100, 200 includes the first axle differential arrangement 116, 216, a second axle differential arrangement 152, 252, a drop gear arrangement 108, 269, an inter-axle differential 110, 267, and an under-drive arrangement 108, 266. Then a drive ratio for the first axle drive pinion 114, 270 is selected for the first axle differential arrangement 116, 216 that minimizes a power consumption of the drive axle system 100, 200. Then a drive ratio for a second axle drive pinion 150, 250 is selected for the second axle differential arrangement 152, 252 that minimizes a power consumption of the drive axle system 100, 200. Then a drive ratio for the drop gear arrangement 108, 269 is selected that minimizes a power consumption of the drive axle system 100, 200. Lastly, a drive ratio for the under-drive arrangement 108, 266 is selected that results in the previously selected overall drive ratio for the drive axle system 100, 200.

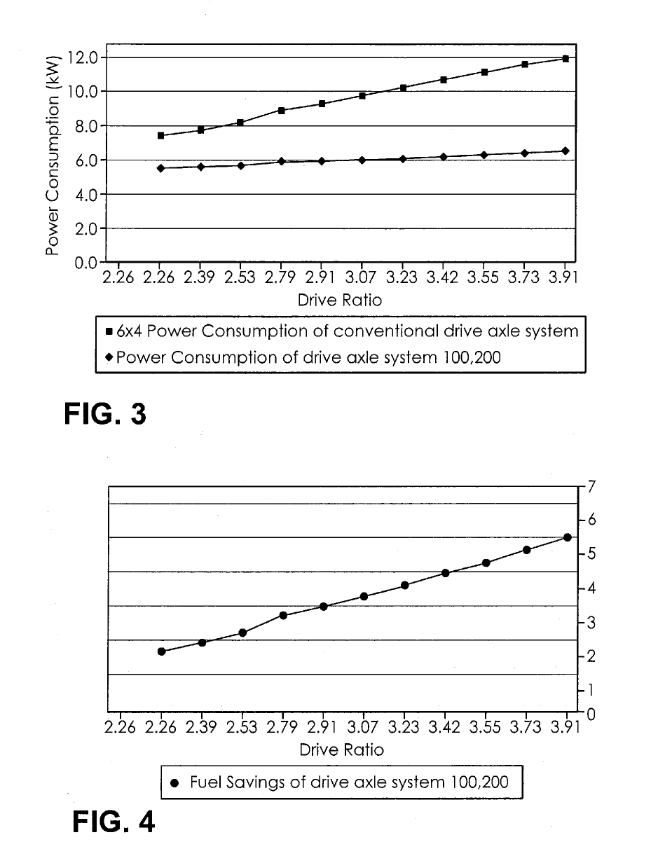

FIG. 3 is a line chart illustrating an amount of power consumption (in kW) versus a drive ratio of both a conventional drive axle system and the drive axle systems 100, 200 according to the embodiments of the invention. A horizontal axis of the line chart indicates a drive ratio with which the conventional drive axle system or the under-drive arrangement 108, 266 may be configured with. A vertical axis of the chart indicates a power consumption (in kW) of the conventional drive axle system or the drive axle systems 100, 200. As shown in FIG. 3, the conventional drive axle system has a variable power consumption based on a drive ratio with which the conventional drive axle system is configured with. As mentioned hereinabove, it is well known in the art that power losses of bearings increase as rotational speed does. The drive axle systems 100, 200 of the present invention reduce power consumption (which primarily occurs due to losses present in the operation of the bearings 120, 220 at increased speeds) of the drive axle systems 100, 200 by isolating all of the drive ratio adjustment to the under-drive arrangement 108, 266. As shown in FIG. 3, the power consumption (in kW) the drive axle systems 100, 200 is reduced from a minimum of about 15% at a drive ratio of 2.26 to a maximum of about 48% at a drive ratio of 3.91 when compared to the power consumption of the conventional drive axle system.

FIG. 4 is a line chart illustrating an amount of fuel savings (in percentage) versus a drive ratio of the drive axle systems 100, 200 according to the embodiments of the invention. A horizontal axis of the line chart indicates a drive ratio with which the under-drive arrangement 108, 266 may be configured with. A vertical axis of the chart indicates the fuel savings (in percentage) of the drive axle systems 100, 200. Because the drive axle systems 100, 200 of the present invention reduce power consumption (which primarily occurs due to losses present in the operation of the bearings 120, 220 at increased speeds) of the drive axle systems 100, 200 by isolating all of the drive ratio adjustment to the under-drive arrangement 108, 266, the drive axle systems 100, 200 decrease fuel consumption of a vehicle the drive axle systems are incorporated in. As shown in FIG. 4, the fuel consumption (in percentage) of the drive axle systems 100, 200 is decreased by about 2% at a drive ratio of 2.26 to a maximum of about 5.8% at a drive ratio of 3.91 when compared to the fuel consumption of the conventional drive axle system.

In accordance with the provisions of the patent statutes, the present invention has been described in what is considered to represent its preferred embodiments, however, it should be noted that the invention can be practiced otherwise than as specifically illustrated and described without departing from its scope or spirit.

What is claimed is:

1. An axle assembly, comprising:
an input shaft in driving engagement with a source of rotational energy;
an under-drive arrangement in driving engagement with the input shaft
an inter-axle differential in driving engagement with the under-drive arrangement; and
an axle differential arrangement in driving engagement with a portion of the inter-axle differential, wherein the under-drive arrangement is configured to reduce a drive ratio of the axle assembly between the input shaft and the inter-axle differential.

2. The axle assembly according to claim 1, wherein the under-drive arrangement is the exclusive drive ratio adjusting component of the axle assembly.

3. The axle assembly according to claim 1, wherein the under-drive arrangement comprises a pair of helical gears in driving engagement with one another.

4. The axle assembly according to claim 1, further comprising a drop gear arrangement in driving engagement with the inter-axle differential and the axle differential arrangement.

5. The axle assembly according to claim 4, further comprising an axle drive pinion in driving engagement with the drop gear arrangement and the axle differential arrangement.

6. The axle assembly according to claim 5, wherein the axle drive pinion and the axle differential arrangement are in a 1:1 drive ratio.

7. The axle assembly according to claim 4, wherein the drop gear arrangement comprises a pair of helical gears in driving engagement with one another.

8. The axle assembly according to claim 7, wherein the pair of helical gears of the drop gear arrangement are in a 1:1 drive ratio.

9. The axle assembly according to claim 1, further comprising a drop gear arrangement in driving engagement with the inter-axle differential and an output shaft of the axle assembly.

10. The axle assembly according to claim 9, further comprising an axle drive pinion in driving engagement with the inter-axle differential and the axle differential arrangement.

11. The axle assembly according to claim 10, wherein the axle drive pinion and the axle differential arrangement are in a 1:1 drive ratio.

12. The axle assembly according to claim 9, wherein the drop gear arrangement comprises a pair of helical gears in driving engagement with one another.

13. The axle assembly according to claim 12, wherein the pair of helical gears of the drop gear arrangement are in a 1:1 drive ratio.

14. The axle assembly according to claim 1, wherein the axle assembly is a low entry axle assembly.

15. The axle assembly according to claim 1, wherein the axle assembly is a high entry axle assembly.

16. A drive axle system, comprising:
a first axle assembly comprising:
an input shaft in driving engagement with a source of rotational energy,
an under-drive arrangement in driving engagement with the input shaft,
an inter-axle differential in driving engagement with the under-drive arrangement,
an output shaft in driving engagement with a first portion of the inter-axle differential, and
a first axle differential arrangement in driving engagement with a second portion of the inter-axle differential; and
a second axle assembly in driving engagement with the output shaft comprising a second axle differential arrangement, wherein the under-drive arrangement is configured to reduce a drive ratio of the first axle assembly and the second axle assembly between the input shaft and the inter-axle differential.

17. The drive axle system according to claim 16, wherein the under-drive arrangement is the exclusive drive ratio adjusting component of the drive axle system.

18. The drive axle system according to claim 16, wherein the under-drive arrangement comprises a pair of helical gears in driving engagement with one another.

19. The drive axle system according to claim 16, wherein the first axle assembly further comprising a drop gear arrangement in driving engagement with the inter-axle differential and the first axle differential arrangement.

20. The drive axle system according to claim 19, further comprising a first axle drive pinion in driving engagement with the drop gear arrangement and the first axle differential arrangement.

21. The drive axle system according to claim 20, wherein the first axle drive pinion and the first axle differential arrangement are in a 1:1 drive ratio.

22. The drive axle system according to claim 19, wherein the drop gear arrangement comprises a pair of helical gears in driving engagement with one another.

23. The drive axle system according to claim 22, wherein the pair of helical gears of the drop gear arrangement are in a 1:1 drive ratio.

24. The drive axle system according to claim 16, further comprising a drop gear arrangement in driving engagement with the inter-axle differential and the output shaft of the first axle assembly.

25. The drive axle system according to claim 24, further comprising a first axle drive pinion in driving engagement with the inter-axle differential and the first axle differential arrangement.

26. The axle assembly according to claim 25, wherein the first axle drive pinion and the first axle differential arrangement are in a 1:1 drive ratio.

27. The drive axle system according to claim 24, wherein the drop gear arrangement comprises a pair of helical gears in driving engagement with one another.

28. The drive axle system according to claim 27, wherein the pair of helical gears of the drop gear arrangement are in a 1:1 drive ratio.

29. The drive axle system according to claim 16, wherein the first axle assembly is a low entry axle assembly.

30. The drive axle system according to claim 16, wherein the first axle assembly is a high entry axle assembly.

31. The drive axle system according to claim 16, wherein the second axle assembly further comprises a second axle drive pinion in driving engagement with the output shaft and the second axle differential arrangement.

32. The drive axle system according to claim 31, wherein the second axle drive pinion and the second axle differential arrangement are in a 1:1 drive ratio.

33. A method of selecting a drive arrangement for a drive axle system, comprising:
selecting an overall drive ratio for the drive axle system, wherein the drive axle system includes a first axle differential arrangement, a second axle differential arrangement, a drop gear arrangement, an inter-axle differential, and an under-drive arrangement;
selecting a drive ratio for a first axle drive pinion and the first axle differential arrangement that minimizes a power consumption of the drive axle system;
selecting a drive ratio for a second axle drive pinion and the second axle differential arrangement that minimizes a power consumption of the drive axle system;
selecting a drive ratio for the drop gear arrangement that minimizes a power consumption of the drive axle system, the drop gear arrangement for driving one of the first axle drive pinion and the second axle drive pinion; and
selecting a drive ratio for the under-drive arrangement that results in the previously selected overall drive ratio for the drive axle system, wherein the under-drive arrangement is drivingly engaged with an input shaft and the inter-axle differential, the outputs of the inter-axle differential drivingly engaged with the drop gear arrangement and one of the first axle drive pinion and the second axle drive pinion.
